(19) United States
(12) Patent Application Publication
(10) Pub. No.: US 2009/0200909 A1
(43) Pub. Date: Aug. 13, 2009

(54) SINGLE BASE FLUORESCENT LAMP AND ILLUMINATION DEVICE

(76) Inventors: Akira Takahashi, Osaka (JP); Kazuhiko Itou, Osaka (JP); Shougo Takahashi, Kyoto (JP)

Correspondence Address: SNELL & WILMER L.L.P. (Panasonic), 600 ANTON BOULEVARD, SUITE 1400, COSTA MESA, CA, 92626, US

(21) Appl. No.: 12/307,206

(22) PCT Filed: Jul. 17, 2007
(86) PCT No.: PCT/JP07/64058

§ 371 Date: Dec. 31, 2008

(30) Foreign Application Priority Data
Aug. 10, 2006 (JP) 2006-218302

(51) Int. Cl. H01J 61/52

(52) U.S. Cl. 313/44

(57) ABSTRACT

The present invention provides a single base fluorescent lamp of a bulb-type or the like that is capable of achieving a peak luminous flux output value when used in a lighting fixture. That is, a lamp (1) has an arc tube (2) that includes therein a spirally-wound spiral part, a pair of electrodes and a winding discharge path, a resin holding member (3) that holds the arc tube (2) such that the arc tube (2) stands, a base (6) for being connected with a lighting apparatus. The present invention has a maximum luminous flux output when a lamp ambient temperature reaches a predetermined temperature of 30° C. or higher.

### TECHNICAL FIELD

The present invention relates to a single base fluorescent lamp.

### BACKGROUND ART

In this age of energy conservation, various bulb-type fluorescent lamps have been developed as power saving light sources in place of incandescent lamps.

FIG. 15 is a front elevational view showing a conventional bulb-type fluorescent lamp 101 as one example.

The bulb-type fluorescent lamp 101 includes a double spiral arc tube 102, an electronic ballast 103, a base 105, and a casing 104 that holds the arc tube 102 such that the arc tube 2 stands, and stores therein the electronic ballast.

Some examples of dimensions and specifications of the lamp 101 (hereinafter, the pertaining lamp is called “conventional lamp”) are as follows.

Maximum external diameter Do . . . 45 mm

Total lamp length Lo . . . 104 mm

Inner tube diameter of a main body (the main part of the arc tube 102 except for a tip portion) . . . 7.4 mm

Bulb wall loading . . . approximately 0.13 W/cm²

Rated lamp wattage . . . 12 W

In general, a bulb-type fluorescent lamp is set such that a maximum luminous flux output can be achieved when a lamp ambient temperature is 25° C.

This is associated with JIS (Japanese Industrial Standards), and also because it is assumed in general that a temperature of an environment in which a lamp is used is 25° C.

Patent Document 1: Japanese Patent Publication No. 2003-263972

### DISCLOSURE OF THE INVENTION

### The Problems to be Solved by the Invention

In recent years, a bulb-type fluorescent lamp has often been used in a shallow compact special lighting fixture that is recessed in a ceiling or the like.

According to investigations by the inventors of the present application, it has been revealed that, in some cases, in the pertaining compact special lighting fixture, a lamp ambient temperature excessively increases due to heat generation by a bulb-type fluorescent lamp during lighting, and thus the ambient temperature becomes higher than the above set temperature of 25° C.

When an ambient temperature becomes higher than the set temperature of 25° C., a luminous flux output decreases, which potentially prevents the rated luminous flux from being obtained.

The present invention, which was conceived in view of the above problem, has an objective to provide a single base fluorescent lamp of a bulb-type or the like that can achieve a peak luminous flux output value even if the single base fluorescent lamp is used in a manner such as the described manner.

### Means to Solve the Problems

In order to achieve the above objective, the single base fluorescent lamp pertaining to the present invention comprises an arc tube which includes therein a pair of electrodes and a double-spiral discharge path, and has an inner tube diameter of 7.4 mm or less, a holding member for holding the arc tube such that the arc tube stands, and a base for connection with a lamp holder, wherein a maximum luminous flux output is obtained when a lamp ambient temperature is a predetermined temperature of 30° C. or higher

Also, in accordance with one aspect of the present invention, the predetermined temperature is 45° C. or lower.

In accordance with one aspect of the present invention, a coldest spot temperature of the arc tube is 55° C. or lower under steady state illumination under a condition in which a lamp ambient temperature is 25° C.

In accordance with one aspect of the present invention, the arc tube has at least one place in which a part of the arc tube in the discharge path connecting the pair of electrodes is 1.2 or more times more swollen than an average inner diameter of the arc tube in the discharge path.

In accordance with one aspect of the present invention, rare gas is enclosed in the arc tube, the rare gas is 100 wt % argon or main components of the rare gas are argon and krypton, and a composition ratio of krypton is 0 wt % to 50 wt % of rare gas.

In accordance with one aspect of the present invention, rare gas is enclosed in the arc tube, main components of the rare gas are argon and xenon, and a composition ratio of xenon is 0 wt % to 25 wt %.

In accordance with one aspect of the present invention, rare gas is enclosed in the arc tube, main components of the rare gas are argon, krypton and xenon, and (R_{Kr}+2R_{Xe}) is in a range of 0 wt % to 50 wt % of the mixed gas where R_{Kr} is a composition ratio of krypton in the mixed gas, and R_{Xe} is a composition ratio of xenon in the mixed gas.

In accordance with one aspect of the present invention, ultraviolet radiation material is one of single mercury and mercury alloy that has an equivalent temperature characteristic regarding mercury vapor pressure to single mercury.

In accordance with one aspect of the present invention, the arc tube is structured to be directly exposed to air without being covered by a covering member.

In accordance with one aspect of the present invention, an inner tube diameter of a main body of the arc tube is 4.0 mm to 7.4 mm.

In accordance with one aspect of the present invention, a bulb wall loading of the arc tube is in a range of 0.07 W/cm² to 0.13 W/cm².

In accordance with one aspect of the present invention, a double-spiral part of the arc tube includes a first spiral part wound to a turning part in a direction and a second spiral part wound from the turning part in another direction that is substantially opposite to the direction, and an inner diameter of the turning part is 1.2 or more times more swollen compared to inner diameters of the first spiral part and the second spiral part.

In accordance with one aspect of the present invention, the arc tube is provided with a thin tube, and a coldest spot is provided in the thin tube during lighting.

A lighting fixture pertaining to the present invention stores therein the single base fluorescent lamp in an airtight manner.

A lighting fixture pertaining to the present invention has the single base fluorescent lamp mounted in substantially a horizontal posture.

### EFFECT OF THE INVENTION

Since the single base fluorescent lamp pertaining to the present invention has a characteristic of having a maximum luminous flux output when a lamp ambient temperature reaches a predetermined temperature of 30° C. or higher, the single base fluorescent lamp pertaining to the present invention can demonstrate its ability in accordance with a condition of a usage pattern of a lamp. Even if, for example, the lamp is mounted in a compact lighting fixture, and is used in an environment in which an ambient temperature becomes higher than 25° C., the lamp can achieve a maximum luminous flux output.

### BRIEF DESCRIPTION OF THE DRAWINGS

FIG. 1 is a front elevational view showing a bulb-type fluorescent lamp 1;

FIG. 2 is a front elevational view showing an arc tube 2 of the bulb-type lamp 1;

FIG. 3 schematically shows a lighting circuit structure of an electronic ballast 4;

FIG. 4 shows a graph comparing luminous flux outputs when a conventional lamp or an invented lamp 1 is mounted in a lighting fixture;

FIG. 5 is a graph showing the relationship between ambient temperature and relative luminous flux;

FIG. 6 includes a graph showing the relationship between R and coldest spot temperature;

FIG. 7 includes a graph showing the relationship between ambient temperature and relative luminous flux with different bulb wall loadings;

FIG. 8 includes a graph showing the relationship between bulb wall loading ratio and coldest spot temperature when bulb wall loading of the conventional lamp is 1;

FIG. 9 shows a graph showing the relationship between an ambient temperature of each of various lamps having different composition of enclosed rare gas and a relative luminous flux;

FIG. 10 includes a graph showing the relationship between Kr mixed ratio and coldest spot temperature;

FIG. 11 shows a graph showing a luminous flux rising characteristic of each lamp having different composition of enclosed rare gas;

FIG. 12 is an exploded view showing a bottom-opened ceiling type lighting fixture 50;

FIG. 13 shows a horizontal lighting down-light type lighting fixture 60;

FIG. 14 is a graph comparing luminous flux outputs in lighting fixtures when the conventional lamp and an invented lamp (one of the invented lamps 1 to 3) are used in each lighting fixture; and

FIG. 15 is a front elevational view showing a conventional bulb-type fluorescent lamp 101.

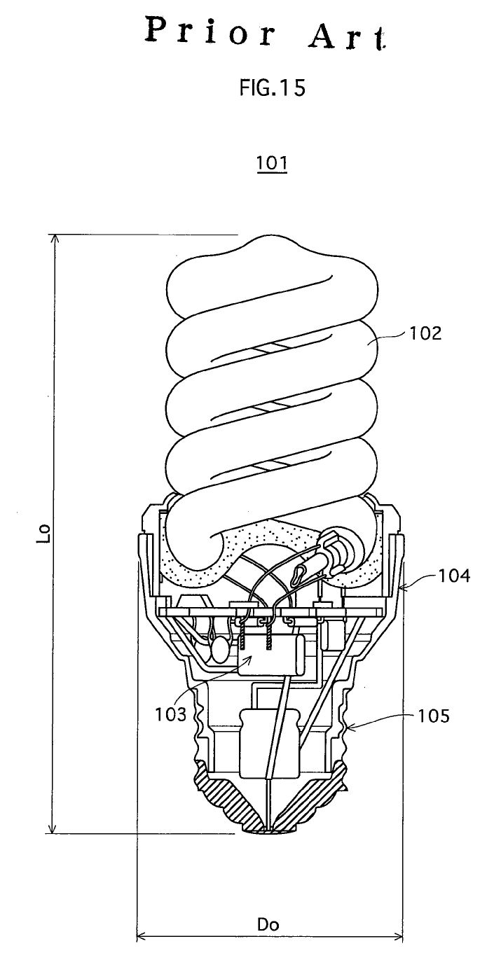

### DESCRIPTION OF NUMERAL REFERENCES

1 bulb type fluorescent lamp
2 arc tube
4 electronic ballast
8 glass tube
8a first spiral part
8b second spiral part
8c turning part
11 swollen part
18 mercury
50 lighting fixture (bottom-opened ceiling type)
60 lighting fixture (horizontal lighting down-light type)

### BEST MODE FOR CARRYING OUT THE INVENTION

### First Embodiment

The following describes an embodiment referring to drawings.

1. Structure of a Bulb-Type Fluorescent Lamp

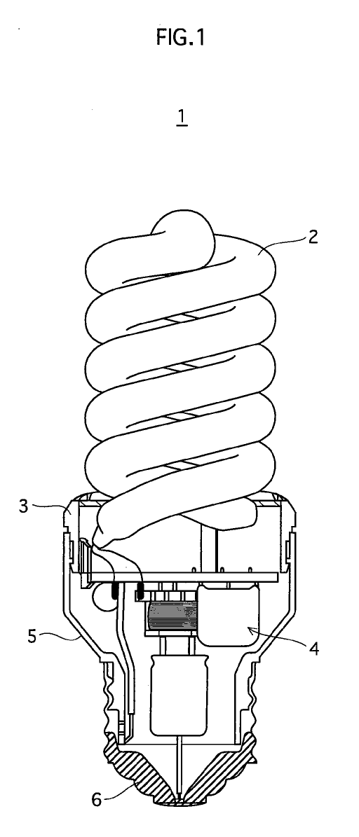

FIG. 1 is a front elevational view showing a bulb-type fluorescent lamp 1.

As shown in FIG. 1, the single base bulb-type fluorescent lamp 1 includes an arc tube 2, a resin holding member 3, an electronic ballast 4, a resin case 5 and a base 6.

The arc tube 2 has a spiral part which is double-spirally wound.

The resin holding member 3 holds the arc tube 2 at both of end portions of the arc tube 2 such that the arc tube 2 stands.

The bulb-type fluorescent lamp 1 has a structure in which the arc tube 2 is not covered by a covering member and is directly exposed to air (non outer bulb type).

The resin casing 5 stores therein an electronic ballast 4. Also, the base 6 is provided at an end portion of the resin casing 5.

2. Structure of an Arc Tube

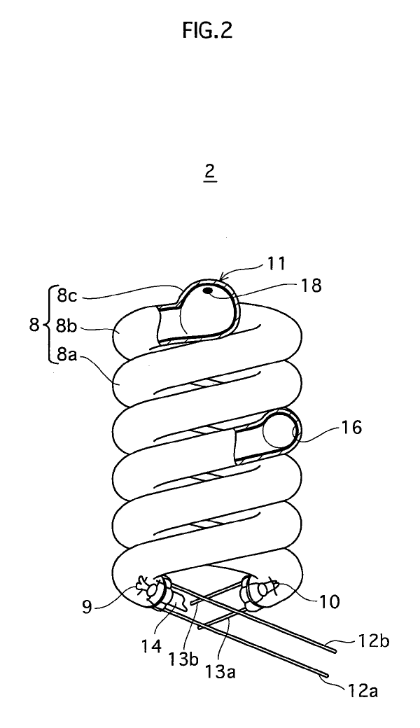

FIG. 2 is a front elevational view showing the arc tube 2 of the bulb-type fluorescent lamp 1, with parts of a glass tube 8 cut such that forms of cross sections of the glass tube 8 can be seen.

The arc tube 2 includes a glass tube 8 that is a tube vessel, and a pair of electrodes 9 and 10 that are disposed at both of end portions of this glass tube 8.

The glass tube 8 is double spiral-shaped, and has a turning part 8c, a first spiral part 8a which is wound from an end portion at which the electrode 9 is disposed to the turning part 8c, and a second spiral part 8b which is wound from the turning part 8c to an end portion at which an electrode 10 is disposed. Since the glass tube 8 is wound many times in such way, a discharge path of the arc tube 2 formed between the electrodes 9 and 10 has a plurality of winging parts.

The turning part 8c at a tip portion of the glass tube 8 is a swollen part 11 which is swollen compared to other main parts. When the lamp 1 is lit, a coldest spot is formed in an inner surface portion of the swollen part 11 having a good heat radiating property. Mercury vapor pressure in the tube at the time of lighting is uniquely determined by a temperature of this coldest spot.

The electrodes 9 and 10 are so-called triple wound filament coils made of tungsten, and are packed with an electron emitting material (not shown) in which Zr oxide is added to Ba—Ca—Sr composite oxide.

Also, the electrodes 9 and 10 are supported by each of a pair of lead lines 12a and 12b, and a pair of lead lines 13a and 13b.

The lead lines 12a and 12b, and the lead lines 13a and 13b are sealed airtight at the end portions of the glass tube 8 using a bead glass mounting method.

Note that an exhausting tube 14 is sealed at one end portion of the glass tube 8 (a tip portion is sealed after exhausting gas from the arc tube).

A phosphor layer 16 is formed in an inner surface of the arc tube 2 except for both of the end portions. The phosphor layer 16 is formed by applying and burning a rare-earth phosphor. Here, the rare-earth phosphor is a mixture of three kinds of phosphors, red, green and blue phosphors.

Also, in addition to mercury (Hg) 18, rare gas (not shown) is enclosed as buffer gas in the arc tube 2. The composition of rare gas is described later.

3. Lighting Circuit Structure of an Electronic Ballast

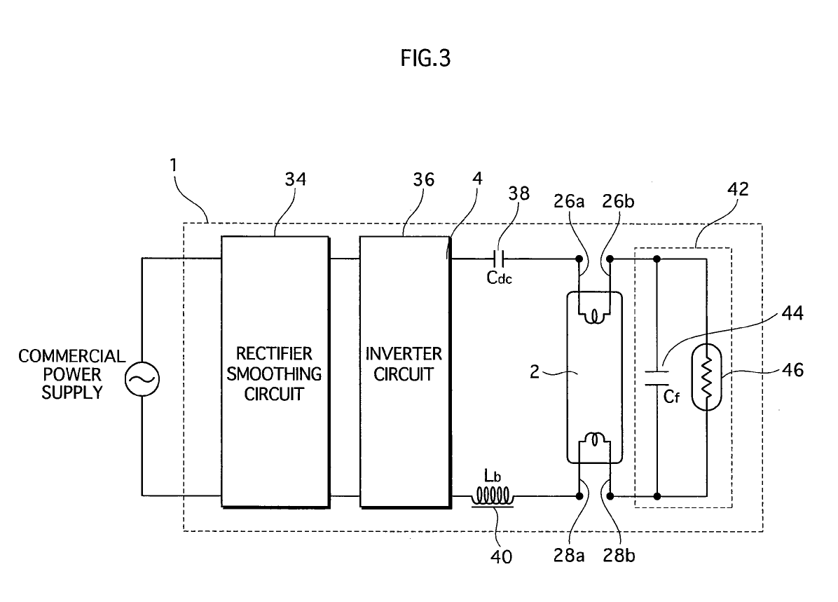

FIG. 3 schematically shows a lighting circuit structure of the electronic ballast 4.

As shown in FIG. 3, the electronic ballast 4 has a lighting circuit structure in which a rectifier smoothing circuit 34, an inverter circuit 36, a DC cut capacitor 38 and a current-limiting choke coil 40 are included.

Note that the circuit efficiency of the electronic ballast 4 is approximately 90%.

A series inverter circuit method is adopted for an inverter circuit unit 36.

The electronic ballast 4 further includes a C preheating circuit 42 which is connected in parallel to lead lines 26b and 28b of the arc tube 2.

The C (capacitor) preheating circuit 42 is composed of a parallel circuit of a capacitor 44 and a positive temperature characteristic resistance element (PTC: Positive Temperature Coefficient) 46.

In addition to supplying preheating current and auxiliary heating current to each of the electrodes 9 and 10 at the start of lamp operation or under steady state illumination, the capacitor 44 fulfills a function of generating starting applied voltage to the arc tube 2 by resonating with the above-stated current-limiting choke coil Lb 40 especially at the start of lamp operation.

Also, the PTC 46 fulfills a function of supplying an adequate amount of preheating current to the electrodes 9 and 10 of the arc tube 2 especially at the start of lamp operation.

4. Method for Increasing an Ambient Temperature at which a Luminous Flux Output Reaches a Peak to a High Temperature

Methods for increasing the ambient temperature at which a luminous flux output reaches a peak to a high temperature of higher than 25° C. include various methods as shown in the following (1) to (3). The following describes, in order, each of the methods and experiment results examined by the present inventors.

(1) Diameter Expansion of the Swollen Part 11

The present inventors manufactured a lamp (hereinafter, “invented lamp 1”) having the same structure as the lamp described using FIGS. 1 to 3 and having a diameter of a swollen part larger than a diameter of a swollen part of a conventional lamp.

The dimensions and specifications of atrial lamp of the invented lamp 1 are as follows.

Inner tube diameter of the main body of the arc tube 2 . . . 6.0 mm

Inner tube diameter of the swollen part 11 . . . . 9.0 mm (1.5 times larger than the main body)

Enclosed rare gas . . . mixed gas of 80 wt % Ar and 20 wt % Kr (enclosed pressure 550 Pa)

Number of winding a tube . . . about 5.5 times

Gap between adjacent winds . . . 1.0 mm

External diameter (outer diameter of the arc tube 2 when the lamp 1 is viewed from above) . . . 32.5 mm

Rated lamp wattage . . . 10 W

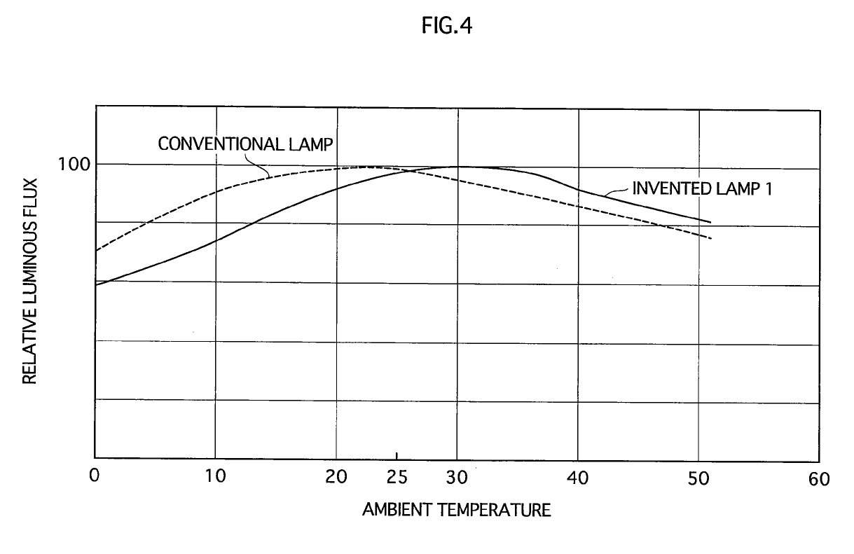

FIG. 4 shows a graph comparing luminous flux outputs when a conventional lamp or the invented lamp 1 is mounted in a lighting fixture.

In the conventional lamp, a luminous flux output reaches a peak at around 25° C. On the other hand, in the invented lamp 1, a luminous flux output reaches a peak at higher than 30° C.

In the present embodiment, in order to increase a peak temperature higher than a peak temperature of the conventional lamp, an inner diameter of the swollen part 11 is made larger compared to an average inner diameter of the main body of the arc tube 2 (light-emitting parts of the arc tube 2 such as spiral parts 8a and 8b) so as to expand an inner surface area of the arc tube.

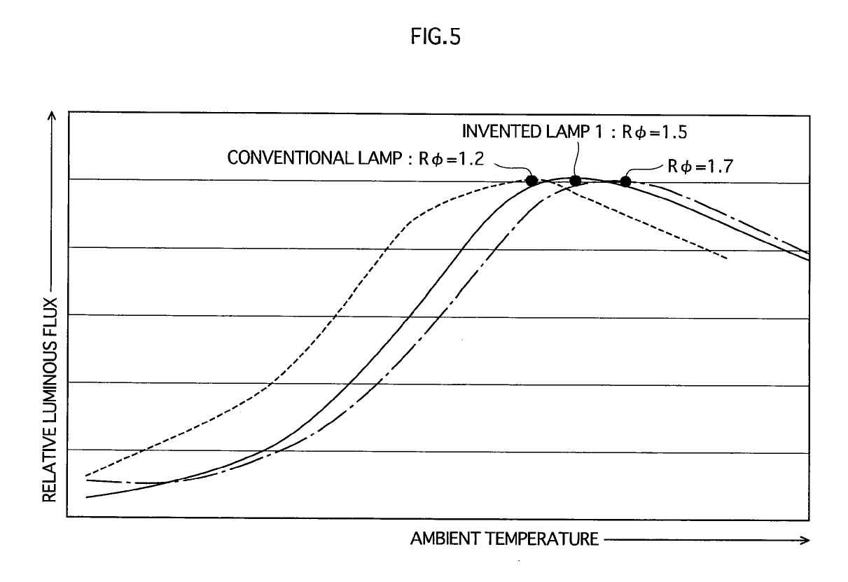

FIG. 5 is a graph showing the relationship between ambient temperature and relative luminous flux.

As shown in FIG. 5, it can be seen that, in the invented lamp 1 whose R is 1.5, an ambient temperature at which a luminous flux output reaches a peak value is higher compared to the conventional lamp whose R is 1.2.

Here, R is a value obtained by dividing an inner diameter (b) of the swollen part by an inner diameter (a) of the main body (R=b/a).

Also, if the inner diameter of the swollen part is 1.7 times larger than the inner diameter of the main body (R=1.7), it is possible to increase an ambient temperature at which the luminous flux output reaches a peak value to a higher temperature.

In this way, the more the inner diameter of the swollen part expands, the greater the adaptability under a high temperature environment becomes. However, in some cases, a thickness of a part which has been swollen due to a diameter expansion becomes thinner. Therefore, an upper limit of the inner diameter of the swollen part is, for example, 2.5 times as large as the inner diameter of the main body.

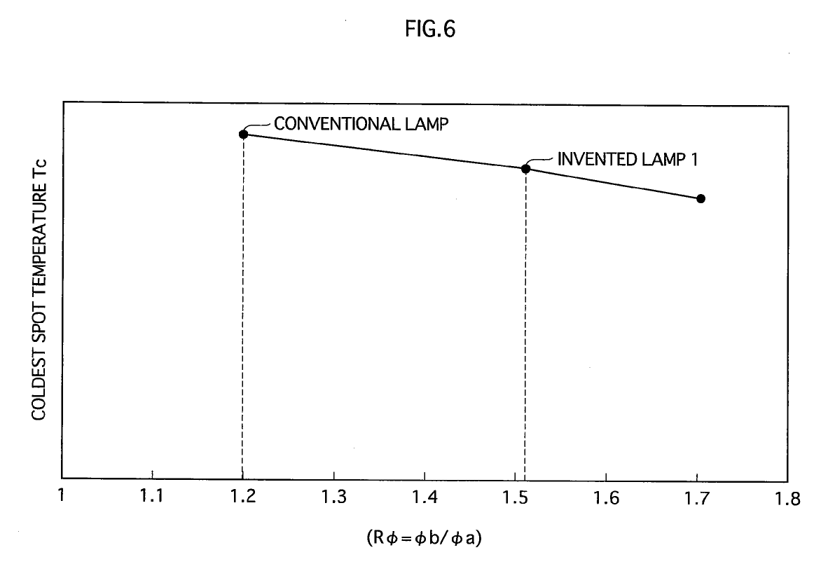

FIG. 6 includes a graph showing the relationship between R and coldest spot temperature.

As shown in FIG. 6, as R becomes larger, the coldest spot temperature under steady state illumination of a lamp (“steady state illumination” is performed when an ambient temperature is 25° C. or lower. The same applies to the following.) decreases. Therefore, even if the invented lamp 1 is used under an environment in which a coldest spot temperature easily rises, it is possible to suppress an excessive increase in a coldest spot temperature, making it possible to obtain a peak luminous flux output value.

(2) Inner Tube Diameter and Bulb Wall Loading

It is possible to increase an ambient temperature at which a luminous flux output takes a peak value to a high temperature by changing the setting of an inner tube diameter and bulb (arc tube) wall loading.

Specifically, a surface temperature of the arc tube 2 during lighting is reduced by suppressing the bulb wall loading. Also, values of the inner tube diameter and the bulb wall loading are set to values that allow the same luminous flux as the conventional lamp to be maintained.

Here, the bulb wall loading is a value obtained by dividing an arc tube wattage (W) by an inner tube surface area between the electrodes (pi×inner tube diameter×distance between electrodes).

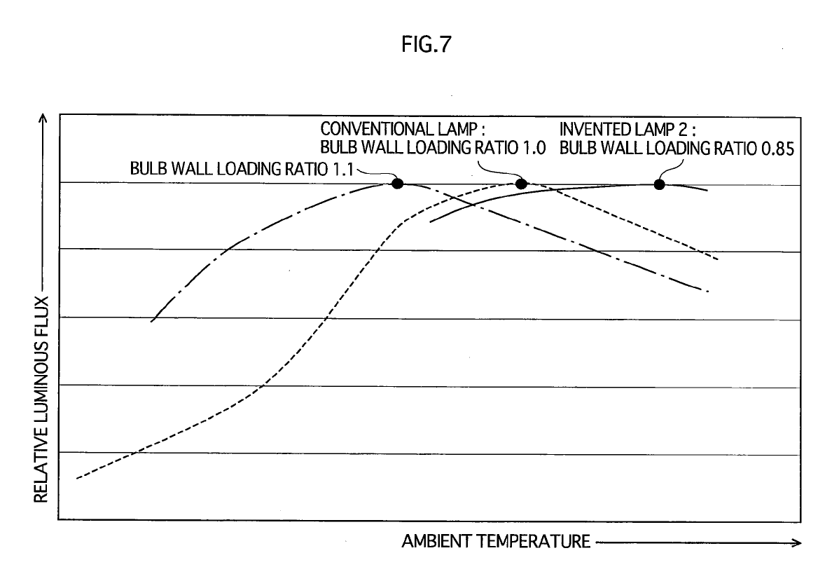

FIG. 7 includes a graph showing the relationship between ambient temperature and relative luminous flux with different bulb wall loadings.

Specifications and dimensions of a lamp which is an invented lamp 2 are the same as the above-stated invented lamp 1 except for a bulb wall loading and an inner diameter. It possible to increase an ambient temperature at which the luminous flux output takes a peak value to a high temperature by suppressing the bulb wall loading more compared to the bulb wall loading of the conventional lamp.

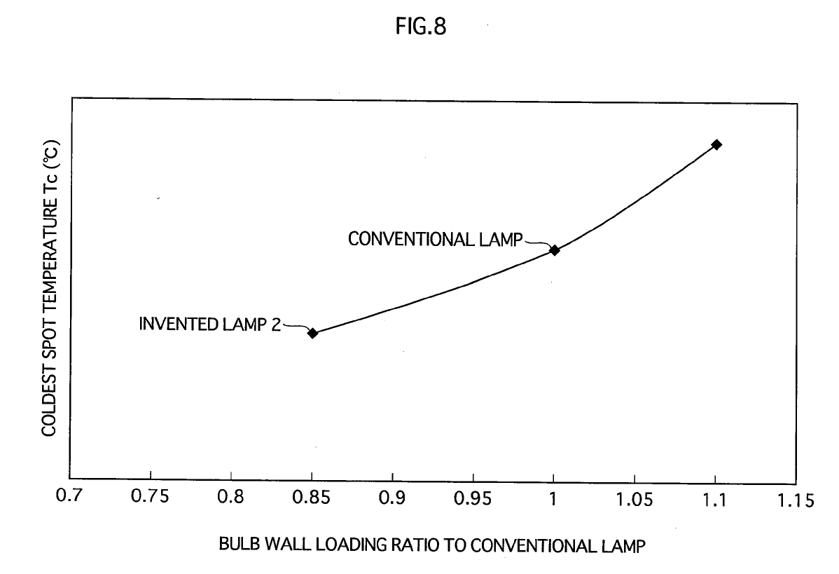

FIG. 8 includes a graph showing the relationship between bulb wall loading ratio and coldest spot temperature when bulb wall loading of the conventional lamp is 1.

As shown in FIG. 8, a coldest spot temperature of the invented lamp 2 under steady state illumination of a lamp (an ambient temperature is 25° C.) is low compared to the conventional lamp.

Note that since an inner tube diameter needs to be smaller and a length of a discharge path needs to be extended in order to (i) avoid a decrease in luminous flux due to suppression of bulb wall loading, and (ii) decrease the bulb wall loading compared to the bulb wall loading of the conventional lamp, the inner tube diameter needs to be smaller than 7.4 mm which is an inner tube diameter of the conventional lamp. Also, if the inner tube diameter is smaller than 4.0 mm, lamp voltage rises, which makes it difficult to stably light a lamp with a lighting circuit that is compact and low in price. Therefore, it is preferable that the inner tube diameter is 4.0 mm to 7.4 mm.

Also, if the bulb wall loading becomes lower than 0.07 W/cm², a total tube length of the glass tube 8 of the arc tube 2, in particular, excessively increases, which makes a forming process of the glass tube 8 extremely difficult and also makes it difficult to keep an external shape of the lamp substantially equal to an external form of a general incandescent lamp (60 W). Since the bulb wall loading needs to be smaller than 0.13 W/cm² which is the bulb wall loading of the conventional lamp, it is preferable that the bulb wall loading is 0.07 W/cm² to 0.13 W/cm².

(3) Composition of Rare Gas

By enclosing, as rare gas to be enclosed in the arc tube 2, mixed gas in which xenon or krypton is added to argon, it is possible to increase an ambient temperature at which the luminous flux output reaches a peak value to a high temperature.

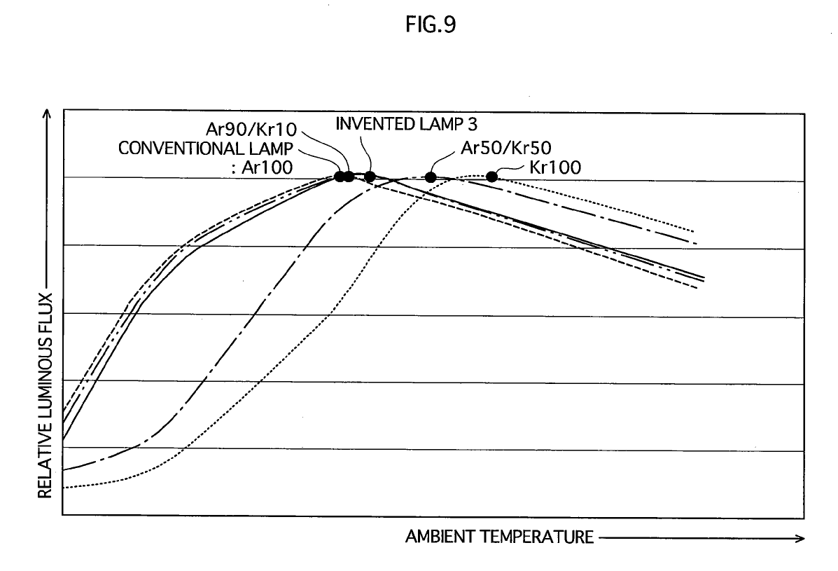

FIG. 9 shows a graph showing a relation between an ambient temperature of each of various lamps having different composition of enclosed rare gas and a relative luminous flux.

FIG. 9 shows that Ar80/Kr20, for example, is a lamp in which mixed gas of 80% wt Ar and 20 wt % Kr is enclosed as rare gas.

As shown in FIG. 9, as ratios of Kr increase like Ar100 (the conventional lamp), Ar90/Kr10, Ar80/Kr20 (an invented lamp 3), Ar50/Kr50 and Kr100, ambient temperatures at which the luminous flux outputs reach peak values increase to high temperatures.

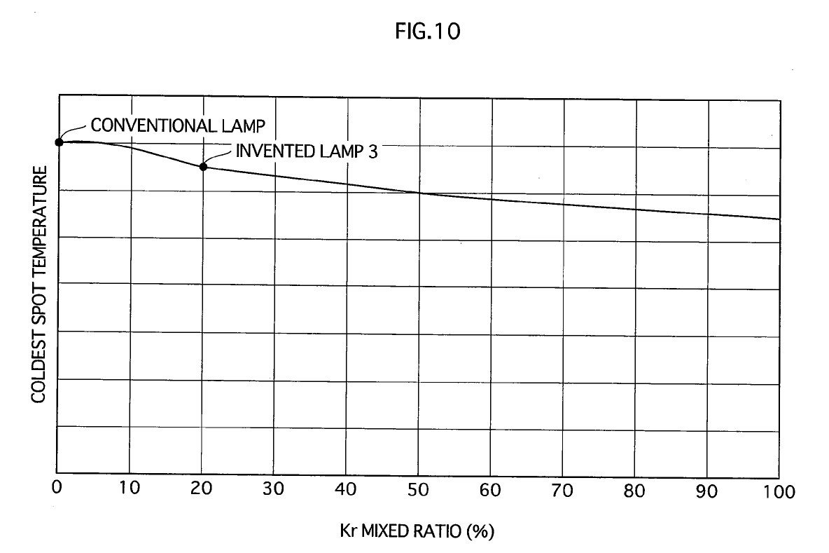

FIG. 10 includes a graph showing the relationship between Kr mixed ratio and coldest spot temperature.

As shown in FIG. 10, as the Kr mixed ratio increases, a coldest spot temperature under steady state illumination (ambient temperature is 25° C.) decreases.

The coldest spot temperature decreased due to a Kr gas mixture. This is because a coefficient of heat conductivity from plasma to a tube inner wall decreased.

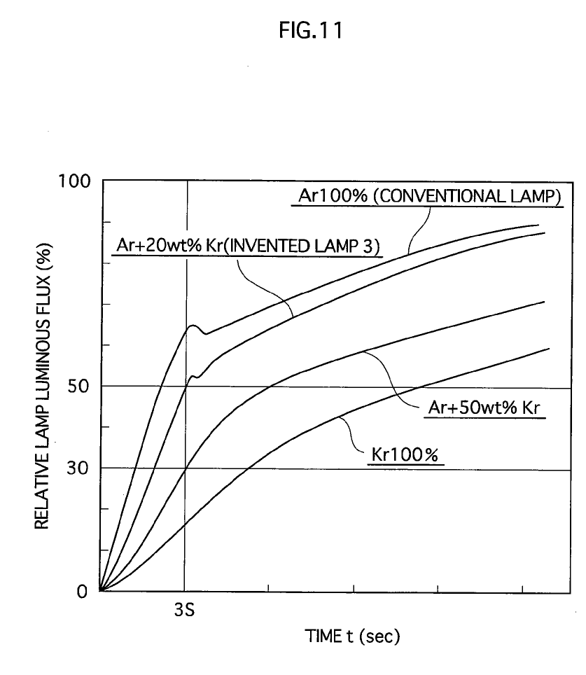

FIG. 11 shows a graph showing a luminous flux rising characteristic of each lamp having different composition of enclosed rare gas.

As shown in FIG. 11, in the invented lamp 3 whose Kr composition ratio R_{Kr} is 20%, it can be ensured that 50% of the luminous flux can rise in three seconds.

On the other hand, in a lamp whose Kr composition ratio R_{Kr} is 50 wt %, about 30% of the luminous flux can rise in three seconds, which is slightly inferior compared to a lamp whose R_{Kr} is 20%. However, this is still within the range in which the lamp can be used without any practical problem.

Since a luminous flux rising characteristic sharply becomes slow in a lamp whose Kr composition ratio R_{Kr} is 100%, it is not preferable to use this lamp as a lamp used under an environment that strictly requires a rising characteristic (an illumination for a lavatory or the like).

Note that the reason why the rising characteristic deteriorates as the Kr composition ratio increases is that the coefficient of heat conductivity of Kr gas is lower compared to Ar gas.

In view of the above, it is appropriate to set the Kr composition ratio R_{Kr} of the (Ar+Kr) mixed gas, in particular, in the range of 0 wt % to 50 wt %.

5. Lighting Fixture

(1) Bottom-Opened Ceiling Fixture

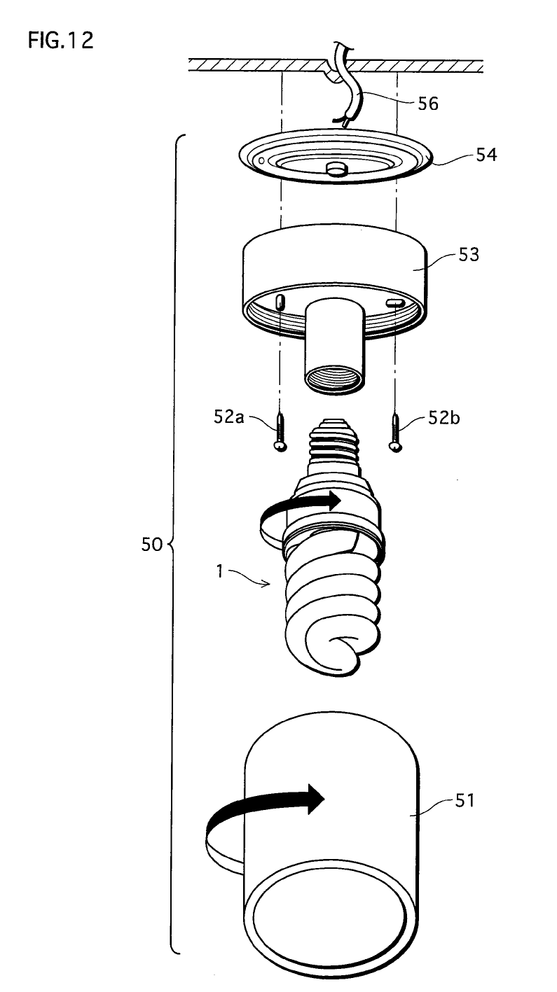

FIG. 12 is an exploded view showing a bottom-opened ceiling type lighting fixture 50.

The lighting fixture 50 includes a bulb-type fluorescent lamp 1, a body 51, a socket 53 and a body packing 54, and the bulb-type fluorescent lamp 1 is mounted in the lighting fixture 50.

The socket 53 is fixed to the body packing 54 by attaching screws 52a and 52b.

Also, the socket 53 is connected to a power electric wire 56.

The body 51 is screwed into the socket 53 so as to be fixed. Therefore, the bulb-type fluorescent lamp 1 is positioned in airtight space, which easily increases an ambient temperature of the lamp 1 to a high temperature of 30° C. or higher when used in the lighting fixture 50.

Since a temperature at which the luminous flux output takes a peak value is a predetermined temperature of 30° C. or higher in the bulb-type fluorescent lamp 1, the luminous flux output in the lighting fixture can be more enhanced compared to the conventional lamp.

(2) Horizontal Lighting Down-Light Fixture

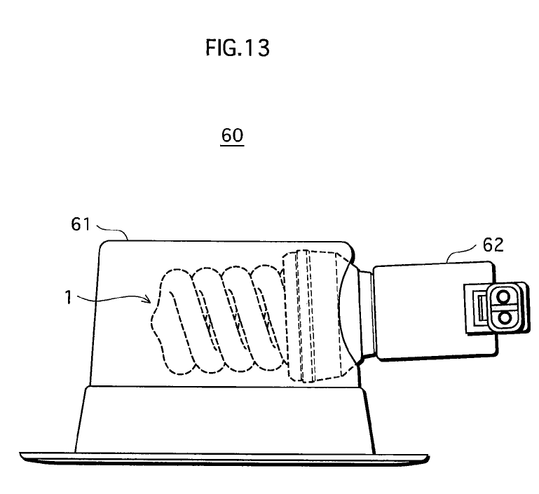

FIG. 13 shows a horizontal lighting down-light type lighting fixture 60.

The lighting fixture 60 includes the bulb-type fluorescent lamp 1, a reflection plate 61 and a socket 62, and the bulb-type fluorescent lamp 1 is mounted in the lighting fixture 60.

Since the bulb-type fluorescent lamp 1 in the lighting fixture 60 is not kept airtight, the ambient temperature of the lamp 1 in the lighting fixture 60 does not tend to remarkably rise compared to the case of using the lamp 1 in the lighting fixture 50.

The lamp 1 is, of course, fixed so as to be lit in substantially a horizontal position. According to investigations by the present inventors, it has been found that horizontal lighting increases a coldest spot temperature, causing problems, in some cases, that a coldest spot temperature becomes beyond the range of an optimum coldest spot temperature, and the luminous flux decreases.

The coldest spot temperature of the bulb-type fluorescent lamp 1 under steady state illumination is lower than a coldest spot temperature of the conventional lamp. Therefore, it is possible to suppress an excessive rise in coldest spot temperature due to lighting the bulb-type fluorescent lamp 1 in a horizontal position, making it possible to set a coldest spot temperature to a coldest spot temperature at which the luminous flux output reaches a peak value.

(3) Comparison

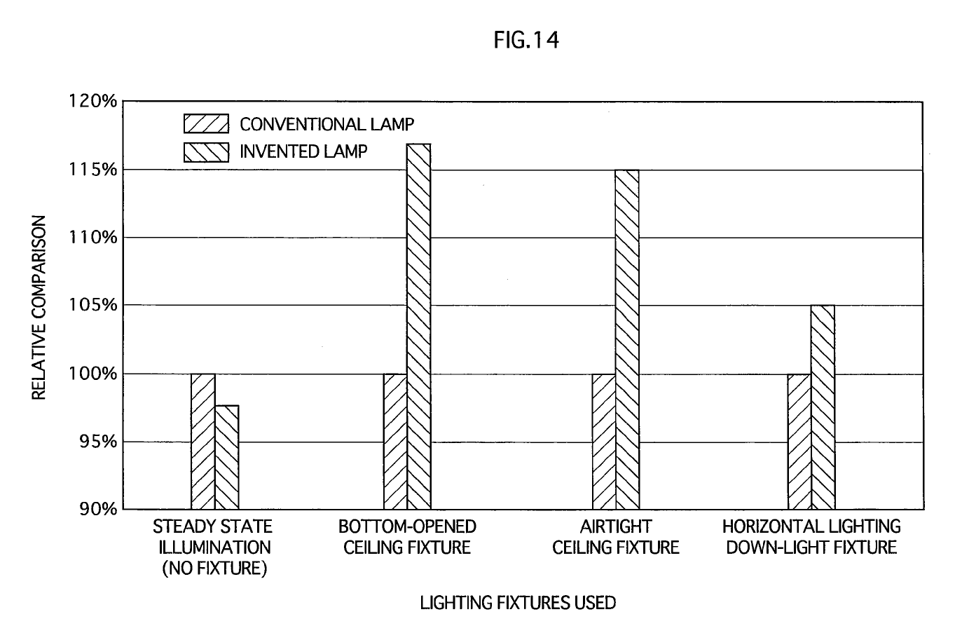

FIG. 14 is a graph comparing luminous flux outputs in lighting fixtures when the conventional lamp and an invented lamp (one of the invented lamps 1 to 3) are used in each lighting fixture.

“Steady state illumination” in a left portion of FIG. 14 is when steady state illumination is performed with the conventional lamp or an invented lamp not mounted in any of the lighting fixtures. In this case, since an ambient temperature is 25° C., the luminous flux output of the conventional lamp reaches a peak value, and the luminous flux output of the invented lamp is below the peak value. Thus, the result shows that the invented lamp is a little inferior compared to the conventional lamp.

On the other hand, in a “bottom-opened ceiling fixture” (for example, see FIG. 12) and an “airtight ceiling fixture” in each of which a bulb-type fluorescent lamp is stored airtight, a better result is obtained when the invented lamp is used than when the conventional lamp is used.

Also, in a “horizontal lighting down-light fixture” (for example, see FIG. 13) in which a bulb-type fluorescent lamp is mounted in substantially a horizontal position, a better result is obtained when the invented lamp is used.

Thus, it can be seen that although the invented lamps are slightly inferior in luminous flux output, with little influence on practical use, compared to the conventional lamp, the invented lamps can give full scope to their ability when used in the lighting fixtures.

6. Other

(1) In the embodiment, single mercury 18 (see FIG. 2) is enclosed as ultraviolet radiation material. Single mercury is preferable because the luminous flux rising characteristic at the start of lamp operation is good particularly compared to amalgam whose mercury vapor pressure at the start of lamp operation decreases.

Note that since the ultraviolet radiation material is not limited to single mercury, mercury alloy having an equivalent temperature characteristic regarding mercury vapor pressure to single mercury may be used.

(2) It is preferable to set a predetermined ambient temperature at which a lamp luminous flux output reaches a peak value in the range of 30° C. to 45° C.

If an ambient temperature is 30° C. or higher, it is possible to obtain a significant effect compared to a conventional lamp whose ambient temperature is set to 25° C.

Also, it is not preferable to set an ambient temperature to 45° C. or higher because the luminous flux output at low temperature decreases, relatively slowing a rise of the luminous flux.

(3) Preferably, a coldest spot temperature of a lamp is lower than 60° C. to 65° C. which is the coldest spot temperature at which the luminous flux output reaches a peak value in the conventional lamp. In particular, it is preferable to set the coldest spot temperature to 55° C. or lower.

If the coldest spot temperature is set to 55° C. or lower, it is possible, for example, to reliably increase an ambient temperature at which the luminous flux output takes a peak value to 30° C. or higher which is higher than 25° C.

(4) In addition to the lamps in each of which the (Ar+Kr) mixed gas is enclosed as described in the embodiment, a lamp 1 which is composed of the arc tube 2 in which (Ar+Xe) mixed gas, in particular, is enclosed is manufactured, and the same measurements as the above-stated measurements are performed. As a result of these measurements, it has been found that substantially the same effect as the above-stated effect can be obtained for the lamp 1 in which (Ar+Xe) is enclosed, especially when Xe composition ratio R_{Xe} is half the Kr composition ratio R_{Kr} of the lamp 1 in which (Ar+Kr) is enclosed. Also, it is appropriate to set the Xe composition ratio R_{Xe} of the lamp 1, in particular, in the range of 0 wt % to 25 wt % for the same reason as the lamp 1 in which (Ar+Kr) is enclosed.

Also, it has been confirmed that there is no adverse effect even if a trace of helium (He) and neon (Ne) that are rare gases (e.g. a sum of both of helium and neon is 2 wt % or less) are mixed in the mixed gas.

(5) Although the turning part 8c of the arc tube 2 is a swollen part 11 in the embodiment, a part in which a swollen part is formed is not limited to this. The part in which the swollen part is formed can be any other part as long as the swollen part is formed between the electrodes 9 and 10 of the arc tube 2. Also, in the case of having a structure in which a coldest spot is formed by connecting a thin tube like a part of the arc tube (e.g. an exhausting tube), it is possible to obtain the same effect as the present invention by setting a coldest spot temperature in the range of the invention.

Also, in the embodiment, as one example of single base fluorescent lamps, a description is given, taking the bulb-type fluorescent lamp with the built-in electronic ballast as an example. However, the present invention can be applied to a fluorescent lamp with no built-in electronic ballast. Also, as an arc tube having a bent part, an arc tube having a shape in which U-shaped tubes are connected to each other, or a twin type arc tube in which a straight tube is bent, for example, may be used. Also, the present invention can be applied to a twin-type single base fluorescent lamp in which either of such arc tubes is held so as to stand on a pin-type base. In the case of having each of these shapes, a part that is swollen (i.e. a swollen part) needs to be provided in a discharge path. This enables a coldest spot to be formed in this swollen part.

(6) FIG. 9 illustrates a lamp whose enclosed ratio of rare gas is 100% Ar, and a lamp whose enclosed ratio of rare gas is 100% Kr. In manufacturing, however, air or the like might be mixed in at the time of enclosing rare gas. Therefore, a ratio of rare gas is not strictly 100.00 wt % Ar or 100.00 wt % Kr. Therefore, it can be assumed that other rare gas (around 0.3 wt %), for example, is mixed in.

### INDUSTRIAL APPLICABILITY

Since the single base fluorescent lamp pertaining to the present invention has a temperature characteristic suitable for utilization of a lamp, it is possible to achieve maximum luminous flux output when the single base fluorescent lamp pertaining to the present invention is used in a lighting fixture, for example.

1. A single base fluorescent lamp comprising:
an arc tube which includes therein a pair of electrodes and a winding discharge path;
a holding member for holding the arc tube such that the arc tube stands; and
a base for connection with a lamp holder, wherein
a maximum luminous flux output is obtained when a lamp ambient temperature is a predetermined temperature of 30° C. or higher.

2. The single base fluorescent lamp of claim 1, wherein
the predetermined temperature is 45° C. or lower.

3. The single base fluorescent lamp of claim 1, wherein
a coldest spot temperature of the arc tube is 55° C. or lower under steady state illumination under a condition in which a lamp ambient temperature is 25° C.

4. The single base fluorescent lamp of claim 1, wherein
the arc tube has at least one place in which a part of the arc tube in the discharge path connecting the pair of electrodes is 1.2 or more times more swollen than an average inner diameter of the arc tube in the discharge path.

5. The single base fluorescent lamp of claim 1, wherein
rare gas is enclosed in the arc tube,
the rare gas is 100 wt % argon or main components of the rare gas are argon and krypton, and
a composition ratio of krypton is 0 wt % to 50 wt % of rare gas.

6. The single base fluorescent lamp of claim 1, wherein
rare gas is enclosed in the arc tube,
main components of the rare gas are argon and xenon, and
a composition ratio of xenon is 0 wt % to 25 wt %.

7. The single base fluorescent lamp of claim 1, wherein
rare gas is enclosed in the arc tube,
main components of the rare gas are argon, krypton and xenon,
(R_{Kr}+2R_{Xe}) is in a range of 0 wt % to 50 wt % of the mixed gas where R_{Kr} is a composition ratio of krypton in the mixed gas, and R_{Xe} is a composition ratio of xenon in the mixed gas.

8. The single base fluorescent lamp of claim 1, wherein
ultraviolet radiation material is one of single mercury and mercury alloy that has an equivalent temperature characteristic regarding mercury vapor pressure to single mercury.

9. The single base fluorescent lamp of claim 1, wherein
the arc tube is structured to be directly exposed to air without being covered by a covering member.

10. The single base fluorescent lamp of claim 1, wherein
an inner tube diameter of a main body of the arc tube is 4.0 mm to 7.4 mm.

11. The single base fluorescent lamp of claim 1, wherein
a bulb wall loading of the arc tube is in a range of 0.07 W/cm² to 0.13 W/cm².

12. The single base fluorescent lamp of claim 1, wherein
the arc tube is spiral-shaped,
a spiral part of the arc tube has a double spiral form, and has a first spiral part which is wound to a turning part in a direction, and a second spiral part which is wound from the turning part in another direction substantially opposite to the direction, and
an inner diameter of the turning part is 1.2 or more times more swollen compared to inner diameters of the first spiral part and the second spiral part.

13. The single base fluorescent lamp of claim 1, wherein
the arc tube is provided with a thin tube, and
a coldest spot is provided in the thin tube during lighting.

14. A lighting fixture storing therein the single base fluorescent lamp of claim 1 in an airtight manner.

15. A lighting fixture having the single base fluorescent lamp of claim 1 mounted in substantially a horizontal posture.
